(19) United States
(12) Patent Application Publication
(10) Pub. No.: US 2023/0324895 A1
(43) Pub. Date: Oct. 12, 2023

(54) MACHINE TOOL

(71) Applicant: HOMAG Bohrsysteme GmbH, Herzebrock-Clarholz (DE)

(72) Inventors: Michael KRUSE, Herzebrock-Clarholz (DE); Werner BRINKHAUS, Wildberg (DE); Vera ZIMMERMANN, Bad Rippoldsau-Schapbach (DE)

(73) Assignee: HOMAG Bohrsysteme GmbH, Herzebrock-Clarholz (DE)

(21) Appl. No.: 18/043,481

(22) PCT Filed: Aug. 31, 2021
(86) PCT No.: PCT/EP2021/073984

§ 371 Date: Feb. 28, 2023

(30) Foreign Application Priority Data
Sep. 1, 2020 (DE) 10 2020 122 809.0

(51) Int. Cl. G05B 19/418; B23Q 11/00; B25J 11/00

(52) U.S. Cl. CPC G05B 19/41895; B23Q 11/0075; B25J 11/005; G05B 2219/50393

(57) ABSTRACT

A machine tool for machining workpieces having at least in parts of wood, wood materials, plastic, composite material or the like, includes: a machining unit for performing workpiece machining, a supporting table for supporting workpieces to be machined, and an assistance robot which is arranged at least temporarily on or above the supporting table and which includes a transport device that enables it to move with respect to the supporting table. A navigation system including at least one sensor is provided for navigating the assistance robot with respect to the supporting table.

### TECHNICAL FIELD

The invention relates to a machine tool for machining workpieces preferably consisting at least in parts of wood, wood materials, plastic, composite material or the like, as according to the preamble of patent claim 1.

### PRIOR ART

In the furniture and components industry, machine tools comprising a supporting table, on which the workpieces are supported and fixed, are often used in addition to so-called throughput systems. In addition, a machining unit is provided which moves with respect to the supporting table and the workpiece in order to perform workpiece machining. Such a CNC machine is disclosed in DE 10 2006 052 017 B4, for example. This citation discloses a safety concept which is supposed to make it easier and safer for an operator to approach the machine tool.

In addition, US 2016/311076 A1 discloses a cleaning robot which removes machining chips from a supporting table. In doing so, the robot travels along a predefined path on the machining table.

Moreover, there has been an increasing trend in recent years that the tasks to be performed by a machine tool become more and more varied and that there is a great deal of pressure for rationalization. At the same time, operational safety continues to be of major importance.

### DESCRIPTION OF THE INVENTION

The invention is based on the object of providing a machine tool of the aforementioned type, which has a broad functionality with a high degree of operational safety.

According to the invention, this object is solved by a machine tool according to claim 1. Particularly preferred further developments of the invention are specified in the dependent claims.

The invention is based on the idea of enabling an assistance robot in a machine tool of the aforementioned type to perform a wide variety of different tasks without restricting operational safety. For this purpose, it is provided, according to the invention, that the machine tool comprises a navigation system comprising at least one sensor for navigating the assistance robot with respect to the supporting table. In this way, the assistance robot is enabled not only to travel along a predefined path on the supporting table, but also to move in principle freely on the supporting table. This opens up completely new possibilities and fields of use for the assistance robot since said assistance robot can now in principle perform all tasks arising in the area of a supporting table.

However, thanks to the navigation system according to the invention, which comprises a sensor, not only the range of possible uses of the assistance robot is increased, but a high degree of operational safety is also achieved and, in addition, also a quick operation of the assistance robot and thus also of the entire machine tool.

Last but not least, the design of the machine tool is also simplified since the assistance robot, thanks to its configuration with a sensor-based navigation system, can replace various complex, space-consuming and expensive machine components which will be discussed in more detail below.

The at least one sensor of the navigation system can in principle be provided at any location or any locations. According to a further development of the invention, however, it is provided that at least one sensor is provided on the assistance robot as such. Thus, the assistance robot can be navigated in a particularly precise manner, and the measuring field of the at least one sensor moves with the assistance robot and thus does not require a drive of its own.

Alternatively or in addition, it is provided, according to a further development of the invention, that at least one sensor is provided laterally of and/or above the supporting table. This results in a more global perspective in which the sensor does not only detect the assistance robot and its immediate environment, but numerous other components or possibly persons can also be detected and thus considered and combined with regard to both operational safety and the various machine functions.

A wide variety of sensor types can be used within the scope of the invention, with the combination of various sensor types also potentially being possible or useful. It has turned out to be advantageous if at least one sensor is selected from a camera, a distance sensor such as in particular a triangulation sensor or a light travel time sensor, an acceleration sensor, a speed sensor, a radar sensor, etc.

In addition, it is provided, according to a further development of the invention, that the machine tool comprises a control device for controlling the movement of the assistance robot with respect to the supporting table. Said control device can be integrated with or provided in addition to the overall control of the machine tool, with an integration or at least communication being advantageous to the effect that the movement of the assistance robot can be coordinated with the operation of the remaining machine components. In this respect, it is particularly preferred that the control device is configured to avoid an undesired collision of the assistance robot with the machining unit of the machine tool. This does not only increase operational safety in general, but also enables an operation of the assistance robot parallel to the main time, in which the assistance robot carries out certain activities in the area of the supporting table also during the performance of a machining operation by the machining unit.

According to a further development of the invention, the freedom of movement of the assistance robot can go so far that the control device is configured to cause a movement of the assistance robot also to or onto a workpiece. The assistance robot can thus also support the smooth and high-quality machining and handling of the respective workpiece in various ways, which opens up completely new possibilities in workpiece machining and achieving high workpiece quality with high efficiency.

According to a further development of the invention, it is further provided that the machine tool comprises a docking station for transferring work elements to the assistance robot and/or for electrically charging the assistance robot. Thus, the performance and flexibility of the machine tool according to the invention are increased since the assistance robot is always supplied with the required work elements and can also switch between different work elements. In this respect, a wide variety of work elements can be considered, as will be seen in more detail in the description below.

All in all, the assistance robot can perform a virtually unlimited variety of different operations within the scope of the present invention. Within the scope of the present invention, however, it has turned out to be particularly advantageous if the assistance robot is configured to perform at least one of the following operations: cleaning a workpiece; cleaning the supporting table; providing a workpiece with a label; picking up, moving and/or depositing a workpiece; analyzing at least one machined structure of a workpiece; supplying and/or assembling an assembly part; supplying, clamping and/or removing a machining tool and/or machining aggregate of the machining unit.

Numerous advantageous units that can be part of the assistance robot and/or can be changed into and changed out of the assistance robot are the subject matter of the dependent claims 8 to 14. They contribute to making the machine tool according to the invention much more versatile while maintaining operational safety high and keeping the design simple.

In addition, it is provided, according to a further development of the invention, that the means of transport of the assistance robot is selected from rollers, wheels, tracks, legs, propellers and combinations thereof. In this way, the movement of the assistance robot can be optimally adapted to the respective boundary conditions of the machine tool.

In this context, it should be noted that, within the scope of the invention, the assistance robot can also be configured in the manner of a drone, i.e. as a flying device that primarily uses one or more propellers as a means of transport. This extremely increases the freedom of movement of the assistance robot and opens up completely new perspectives and possible uses. For example, a drone can overlook the machine tool much better and always bring itself into an optimal position in order to detect the current state of the machine and possible options for action. At the same time, a drone can also access all areas of the machine tool much more flexibly and also easily move directly onto workpieces or into the area above workpieces in order to perform assistance activities or measurements etc. there.

### BRIEF DESCRIPTION OF THE DRAWINGS

FIG. 1 schematically shows a perspective view of a machine tool according to a first embodiment;

FIG. 2 schematically shows a perspective view of an assistance robot according to the first embodiment;

FIG. 3 schematically shows a perspective view of an assistance robot according to the second embodiment;

FIG. 4 schematically shows a perspective view of an assistance robot according to the second embodiment.

### DETAILED DESCRIPTION OF PREFERRED EMBODIMENTS

Preferred embodiments of the invention are described in detail below with reference to the accompanying drawings.

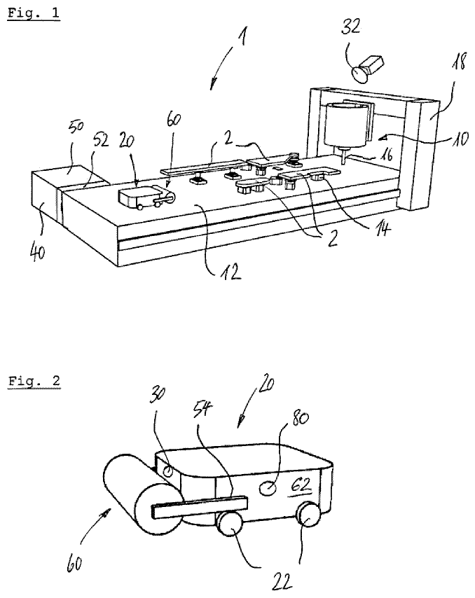

A machine tool 1 for machining workpieces 2 according to a first embodiment of the invention is schematically shown in FIG. 1 in a perspective view. The machine tool 1 is used to machine workpieces 2 consisting for example of wood, wood materials, plastic or various composite materials, as are widely used in the furniture and components industry.

The machine tool 1 first of all comprises a machining unit 10 which, in the present embodiment, is configured as a spindle aggregate into which various machining tools 16 or also machining aggregates can be changed. The machining tools can be, for example, drills, milling cutters, saws, etc. As regards the aggregates, various chip-removing aggregates such as multiple drilling aggregates, pivotable saws, etc. can also be changed. However, coating aggregates for coating a surface of the workpiece 2 or various other aggregates can also be changed, for example. For this purpose, the machining unit 10 can have a corresponding interface.

The machining unit 10 is arranged on a moving gantry 18 which can be moved along a supporting table 12 for supporting the workpieces 2 to be machined. In this respect, the machining unit 10 can be moved along the moving gantry 18 in the horizontal and vertical directions, so that the machining unit 10 can be moved in all spatial directions. In addition, the machining unit 10 can be pivotable about at least one axis, optionally also more axes.

As can be seen from FIG. 1, the workpieces 2 are fixed on the supporting table 12 by means of suitable holding means 14. The holding means 14 can be, for example, suction clamping elements, clamping elements or the like. In the state shown in FIG. 1, the workpieces 2 are machined in that the machining unit 10 is moved with respect to the supporting table 12 while performing machining such as drilling or milling.

In addition, the machine tool 1 shown in FIG. 1 comprises an assistance robot 20 which, in the present embodiment, is located on the supporting table 12 and can move there. The configuration of the assistance robot 20 is shown in more detail in FIG. 2. First of all, it comprises means of transport 22 which, in the embodiment, are configured as driven wheels. However, it should be noted that various other means of transport are also possible, such as rollers, tracks or legs up to propellers. Although not shown in FIG. 2, the assistance robot 20 could thus also be configured as an aerial drone that can freely move above the supporting table 12. However, such an aerial drone can additionally comprise also other means of transport such as wheels, if necessary.

In this respect, the means of transport 22 can also be configured to cause a movement of the assistance robot directly to or even onto a workpiece 2. Thus, the assistance robot 20 is enabled to act also directly on the respective workpieces 2, be it for cleaning purposes or, optionally, for certain machining or alignment purposes. Many other fields of use are possible within the scope of the invention. For example, the assistance robot 20 can also comprise an analysis unit 80 for analyzing at least one machined structure of the workpiece 2, for example in the form of a camera or a measuring head. In the embodiment of the assistance robot 20 shown in FIG. 2, this analysis unit 80 is arranged on the side surface of said assistance robot 20. However, it can also be arranged on various other surfaces such as the lower surface of the assistance robot 20. In this case, the assistance robot 20 can also move across the workpieces in order to analyze their surface.

In order to precisely and safely control the movements of the assistance robot 20 with respect to the supporting table 12, the machine tool 1 comprises a navigation system which, in the present embodiment, is configured by several sensors 3, 32 as well as a control device 40. The control device 40 is shown only schematically and can be located directly next to the supporting table 12 or at another suitable location. It can also be integrated with the general control of the machine tool 1. The control device 40 communicates with a first sensor 30 arranged on the assistance robot 20 as well as a second sensor 32 provided above the supporting table 12 of the machine tool 1. The first sensor 30 monitors the direct environment of the assistance robot 20, the second sensor 32 monitors in principle the entire supporting table 12 as well as other areas and components, if necessary.

In this respect, it should be noted that a larger number of sensors can also be provided as required, for example in order to cover the entire environment of the assistance robot or in order to detect certain areas of the supporting table 12 more precisely. In the present embodiment, the first sensor 30 is a distance sensor such as a triangulation sensor or a light travel time sensor, so that the distance of the assistance robot 20 to objects in its environment can be monitored. In the present embodiment, the second sensor 32 is a camera or a CCD sensor, the image data of which can be evaluated in the control device 40 in a suitable manner.

In addition, the control device is connected to the means of transport 22 of the assistance robot 20 in order to control the movement of the assistance robot 20, taking the detection signals of the sensors 30, 32 into account. In addition to these detection signals, the control device 40 can take other input information into account, such as the current or future machining program of the machining unit 10, the location and geometry of the respectively clamped workpieces 2, etc.

In the present embodiment, the connection of the control device 40 to both the sensors 30, 32 and the means of transport 22 is wireless, so that the movement of the assistance robot 20 is not restricted by a cable connection. However, it is also possible in principle to provide a cable connection for certain connections such as to the sensor 32 or to the general machine control.

All in all, the control device 40 is configured not only to control the general movement of the assistance robot 20 with respect to the supporting table 12, but also to avoid an undesired collision of the assistance robot 20 with other objects such as in particular the machining unit 10. The control device 40 does not take a static view as a basis, but monitors the current and future machining operation of the machining unit 10 by means of the sensors 30 and 32 on the one hand and by means of their connection to the general control of the machine tool 1 on the other hand, thereby ensuring that the assistance robot 20 moves only in areas in which no collision with the machining device 10 is to be expected at the corresponding time. In addition, the control device 40 can also comprise an emergency stop circuit which restricts or terminates the operation of the machining unit 10 if, contrary to expectations, the assistance robot 20 could collide with the machining unit or another relevant object, possibly due to a malfunction or a fault.

As can be seen from FIG. 2, the assistance robot 20 in the present embodiment is equipped with a cleaning unit 60. Said cleaning unit 60 can be used to clean various areas such as a workpiece surface or a surface of the supporting table 12. The cleaning unit 60 can be, for example, a suction unit or a sweeping unit, with substances picked up being able to be collected in a collecting container 62 which can be provided inside the assistance robot 20, for example.

In addition, the machine tool in the embodiment shown in FIG. 1 comprises a docking station 50 which is used to electrically charge the assistance robot 20 on the one hand, but also to supply it with various work elements on the other hand, if necessary. For example, it is possible within the scope of the invention that the assistance robot 20 deposits its work element, which in FIG. 2 is configured as a cleaning unit 60, at the docking station, if necessary, and replaces it with another work element. For this purpose, the assistance robot 20 has an interface 54 via which various work elements 60 can be changed in and out.

In addition, the docking station 50 can also have a transfer interface 52 that supports the process of changing in and out or also supplying various work elements. Although not shown in FIG. 2, the following work elements, for example, which can be provided on the assistance robot 20 or which can be changed into and changed out of the assistance robot 20, are possible within the scope of the invention:
a labeling unit for applying a label to a surface of a workpiece 2, which can comprise a stocking unit 60 for stocking labeling material, if necessary.
an assembly unit for supplying and/or fixing an assembly part (such as a connector) to a workpiece, the assembly unit being able to comprise an assembly part stocking unit 62 for stocking assembly parts, if necessary.

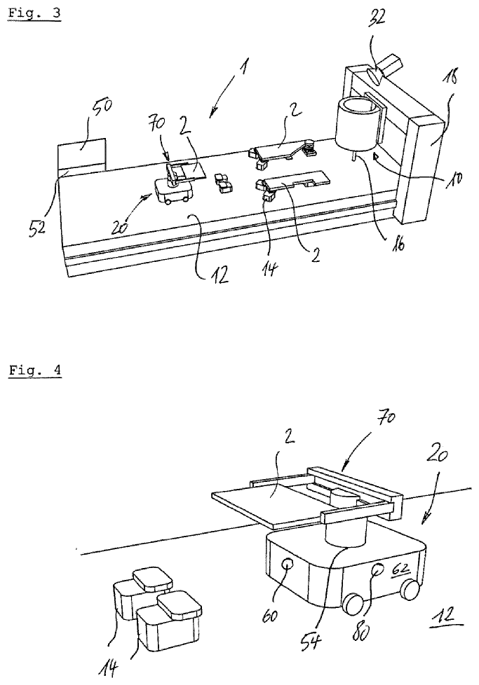

A further embodiment of the machine device 1 according to the invention is schematically shown in FIGS. 3 and 4. It differs from the embodiment described above primarily in that the interface 54 is arranged, by way of example, on an upper surface of the assistance robot 20 and in that a work element 70 in the form of a gripper can be changed into the interface 54. As shown in FIG. 4, the work element 70 can be used, for example, to pick up, move and deposit one workpiece 2 or several workpieces, so that it is a picking unit. In addition, however, the unit 70 can also be used, for example, to supply, clamp or remove a machining tool or a machining aggregate of the machining unit 10, so that in this case it is a tool changing unit.

Alternatively or in addition to changing in and out various work elements 60, 70, the docking station 50 can, however, also be used to transfer various other work elements to the assistance robot 20, such as various consumables, cleaning agents, (pressurized) fluids, assembly parts, data, power, etc. The docking station 50 can also remove load from the assistance robot 20; for example, it can empty the collecting container 62 or receive empty carrier foils (such as for labels).

1-16. (canceled)

17. A machine tool for machining workpieces preferably consisting at least in parts of wood, wood materials, plastic, composite material or the like, comprising:
a machining unit for performing workpiece machining,
a supporting table for supporting workpieces to be machined,
an assistance robot which is arranged at least temporarily on or above the supporting table and which comprises a means of transport that enables it to move with respect to the supporting table,
wherein a navigation system comprising at least one sensor is provided for navigating the assistance robot with respect to the supporting table.

18. The machine tool according to claim 17, wherein at least one sensor is provided on the assistance robot.

19. The machine tool according to claim 17, wherein at least one sensor is provided laterally of and/or above the supporting table.

20. The machine tool according to claim 17, wherein at least one sensor is selected from a camera, a distance sensor such as in particular a triangulation sensor or a light travel time sensor, an acceleration sensor, a speed sensor and a radar sensor.

21. The machine tool according to claim 17, wherein a control device which is preferably configured to avoid an undesired collision of the assistance robot with the machining unit is further provided for controlling the movement of the assistance robot with respect to the supporting table, wherein the control device is preferably configured to cause a movement of the assistance robot also to or onto a workpiece.

22. The machine tool according to claim 17, wherein a docking station is further provided for transferring work elements to the assistance robot and/or for electrically charging the assistance robot.

23. The machine tool according to claim 17, wherein the assistance robot is configured to perform at least one of the following operations: cleaning a workpiece; cleaning the supporting table; providing a workpiece with a label; picking up, moving and/or depositing a workpiece; analyzing at least one machined structure of a workpiece; supplying and/or assembling an assembly part; supplying, clamping and/or removing a machining tool and/or machining aggregate of the machining unit.

24. The machine tool according to claim 17, wherein the assistance robot comprises a cleaning unit for cleaning a workpiece surface and/or a surface of the supporting table, and preferably further comprises a collecting container for collecting substances picked up.

25. The machine tool according to claim 17, wherein the assistance robot comprises a wiping unit for applying a cleaning agent to a workpiece surface and/or for wiping a workpiece surface clean, the wiping unit preferably comprising a cleaning agent storage container.

26. The machine tool according to claim 17, wherein the assistance robot comprises a labeling unit for applying a label to a workpiece surface, the labeling unit preferably further comprising a stocking unit for stocking labeling material.

27. The machine tool according to claim 17, wherein the assistance robot comprises a picking unit for picking up, moving and/or depositing one or more workpieces.

28. The machine tool according to claim 17, wherein the assistance robot comprises an analysis unit for analyzing at least one machined structure of a workpiece, the analysis unit preferably comprising an inspection system, for example a camera and/or a measuring head.

29. The machine tool according to claim 17, wherein the assistance robot comprises an assembly unit for supplying and/or fixing an assembly part to a workpiece, the assembly unit preferably further comprising an assembly part stocking unit for stocking assembly parts.

30. The machine tool according to claim 17, wherein the assistance robot comprises a tool changing unit for supplying, clamping and/or removing a machining tool and/or machining aggregate of the machining unit.

31. The machine tool according to claim 17, wherein the means of transport is selected from rollers, wheels, tracks, legs, propellers and combinations thereof.
